(19) United States
(12) Patent Application Publication
(10) Pub. No.: US 2014/0108050 A1
(43) Pub. Date: Apr. 17, 2014

(54) XTRACT PREPARATION SYSTEM AND METHOD

(71) Applicant: James W Baker, Portland, OR (US)

(72) Inventor: James W Baker, Portland, OR (US)

(21) Appl. No.: 14/047,859

(22) Filed: Oct. 7, 2013

Related U.S. Application Data
(60) Provisional application No. 61/710,647, filed on Oct. 5, 2012.

(51) Int. Cl. G06F 19/00

(52) U.S. Cl. CPC G06F 19/3456
USPC 705/3

(57) ABSTRACT

Embodiments of the invention relate to performing a method for point of care treatment of a patient for safe effective generation of Immunotherapy patient treatment sets. The method includes receiving a command to formulate a prescription; loading contents of each door; receiving a command to load physician preferences; loading physician preferences; receiving a command to load patient information; making prescription per patient information in accordance with physician preferences; printing and applying labels to prescription; and documenting a plurality of clinical activities.

### CLAIM FOR PRIORITY

The present application claims the benefit of Provisional Application No. 61/710,647 filed Oct. 5, 2012 and titled “X-ACT Clinician Documentation and Recordation Method and System” the complete subject matter of which is incorporated herein by reference.

### FIELD OF THE INVENTION

The invention relates to a documentation and recordation method and apparatus. More particularly, the invention relates to an apparatus and method for integrating clinical documentation with the point of care treatment of a patient within a healthcare facility, typically in connection with a patient care system for safe effective generation of immunotherapy patient treatment sets.

### BACKGROUND OF THE INVENTION

It is well known to fill prescriptions (specifically vials for immunotherapy) per a physician's instructions. However, there is a lack of quality and effectiveness in preparing the vials for immunotherapy, in addition to documenting such preparation and filing.

Accordingly, it is an object of the present invention to provide an system of apparatus and method for integrating clinical documentation with the point of care treatment of a patient within a healthcare facility, typically in connection with a patient care system for safe effective generation of immunotherapy patient treatment sets.

These and other objects will be readily evident upon a study of the specification and the accompanying drawing wherein:

### SUMMARY OF THE INVENTION

Embodiments of the invention relate to an apparatus and method for integrating clinical documentation with the point of care treatment of a patient within a healthcare facility, typically in connection with a patient care system for safe effective generation of immunotherapy patient treatment sets.

Embodiments enable a user or clinic to configure the system with their own forms and preferences. This includes loading their “allergen list” of any extract they prescribe with its affiliated lot numbers and outdates. The system allows users to input their desired prescription, input the patient information, and automatically populate and print the prescription sheets, treatment documentation, and vial labels.

A user (or clinic) can choose to use an ID/barcode scanner during the mixing process. Use of the scanner will alert a user if they have selected an extract for preparation which was not prescribed, or an affiliated dose that was not prescribed. Use of these tools will create an “auditable trail” recording all mixing steps with traceability to both the user and the stock extracts used. Each patient label incorporates a unique identifier linking that solution back to its source components. This system is comprised of hardware components combined with software running on the hardware.

One or more embodiments relate to computer-readable media embodying computer-useable instructions for performing a method for point of care treatment of a patient for safe effective generation of immunotherapy patient treatment sets. The method includes receiving a command to formulate a prescription; loading contents of each door; receiving a command to load physician preferences; loading physician preferences; receiving a command to load patient information; and making prescription per patient information in accordance with physician preferences.

Yet another embodiment relates to a non-transitory computer-readable medium containing program code for providing a point of care treatment of a patient for safe effective generation of immunotherapy patient treatment sets including program code for receiving a command to formulate a prescription; program code for loading contents of each door; program code for receiving a command to load physician preferences; program code for loading physician preferences; program code for receiving a command to load patient information; and program code for making per patient information in accordance with physician preferences.

Still another embodiment relates to a system for providing a point of care treatment of a patient for safe effective generation of immunotherapy patient treatment sets including a server configured with a database, the database storing program code for establishing an auction house by enrolling at least one member; program code for receiving a command to formulate a prescription; program code for loading contents of each door; program code for receiving a command to load physician preferences; program code for loading physician preferences; program code for receiving a command to load patient information; and program code for making per patient information in accordance with physician preferences.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 is a high level view of the apparatus in accordance with one embodiment of the present invention;

FIG. 2A-2E is a high level flow chart illustrating integrating clinical documentation with the point of care treatment of a patient within a healthcare facility in connection with a patient care system for safe effective generation of immunotherapy patient treatment sets in accordance with one embodiment of the present invention;

FIG. 3 is a high level flow chart illustrating administration management in accordance with one embodiment of the present invention;

FIG. 4 is a high level flow chart illustrating inventory management in accordance with one embodiment of the present invention;

FIG. 5A-5B is a high level flow chart illustrating mixing management in accordance with one embodiment of the present invention; and

FIG. 6 is a high level flow chart illustrating preferences management in accordance with one embodiment of the present invention.

Throughout the various figures, like reference numbers refer to like elements.

### DETAILED DESCRIPTION OF PRESENTLY PREFERRED EMBODIMENTS

Embodiments of the invention relate to an apparatus and method for integrating clinical documentation with the point of care treatment of a patient within a healthcare facility, typically in connection with a patient care system for safe effective generation of immunotherapy patient treatment sets.

Embodiments enable a user or clinic to configure the system with their own forms and preferences. This includes loading their “allergen list” of any extract they prescribe with its affiliated lot numbers and outdates. The system allows users to input their desired prescription, input the patient information, and automatically populate and print the prescription sheets, treatment documentation, and vial labels.

A user (or clinic) can choose to use an ID/barcode scanner during the mixing process. Use of the scanner will alert a user if they have selected an extract for preparation which was not prescribed, or an affiliated dose that was not prescribed. Use of these tools will create an “auditable trail” recording all mixing steps with traceability to both the user and the stock extracts used. Each patient label incorporates a unique identifier linking that solution back to its source components. This system is comprised of hardware components combined with software running on the hardware.

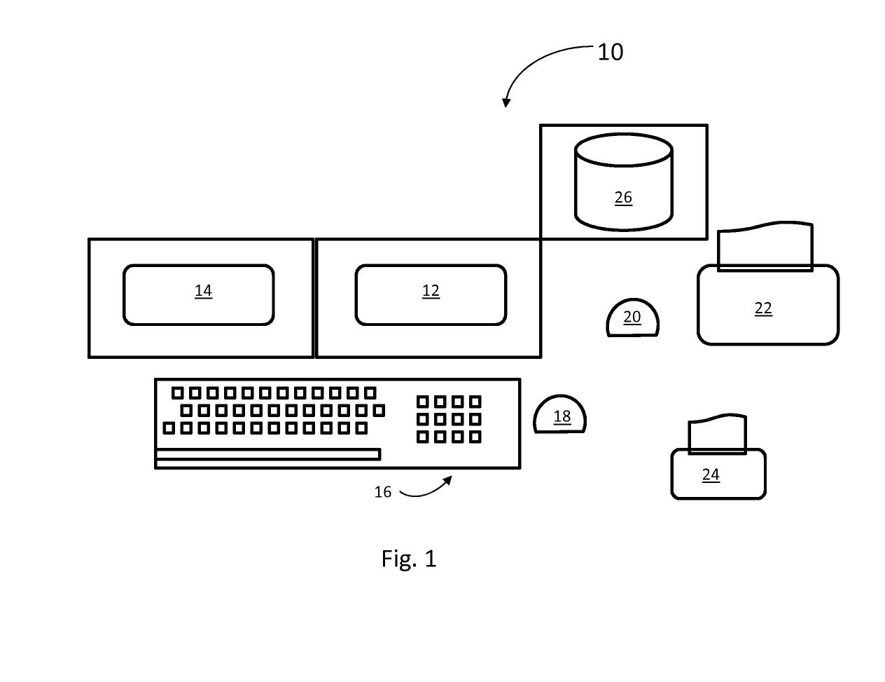

Referring now to the drawings in greater detail, and more particularly to FIG. 1, an apparatus generally designated 10 is depicted. In at least one embodiment the apparatus 10 is adapted to operate in a clinical environment and be easily cleanable via the JCAII guidelines for inclusion in the aseptic field while compounding (“cleanable” with Isopropyl alcohol for example).

The apparatus 10 may include a medical grade touch panel computer 12, display monitor 14, keyboard 16 and mouse 18. Embodiments may include a barcode reader or scanner 20 to read vial identifiers and dosing keys, a paper printer 22, and barcode printer 24 for creating robust water resistant labels for adhesion to the patient vials and paper documents. FIG. 1 further illustrates a server 26 configured with a database containing clinical documentation with point of care treatment of a patient. The individual components may communicate via any cable or wireless method as is well known in the art.

While only one computer 12, display monitor 14, keyboard 16 and mouse 18 are shown communicating with the server and database 26, embodiments may include a plurality of computers 12, display monitors 14, keyboards 16 and/or one or more mouses 18 communicating with the server and database 26. Further, while only one server and database 26 is illustrated, a plurality of servers and databases 26 are contemplated in communication with each other. Alternatively, server and database 26 may include “cloud computing” which includes computing models for enabling ubiquitous, convenient, on-demand network access to a shared pool of configurable computing resources (e.g., networks, servers, storage, applications, and services).

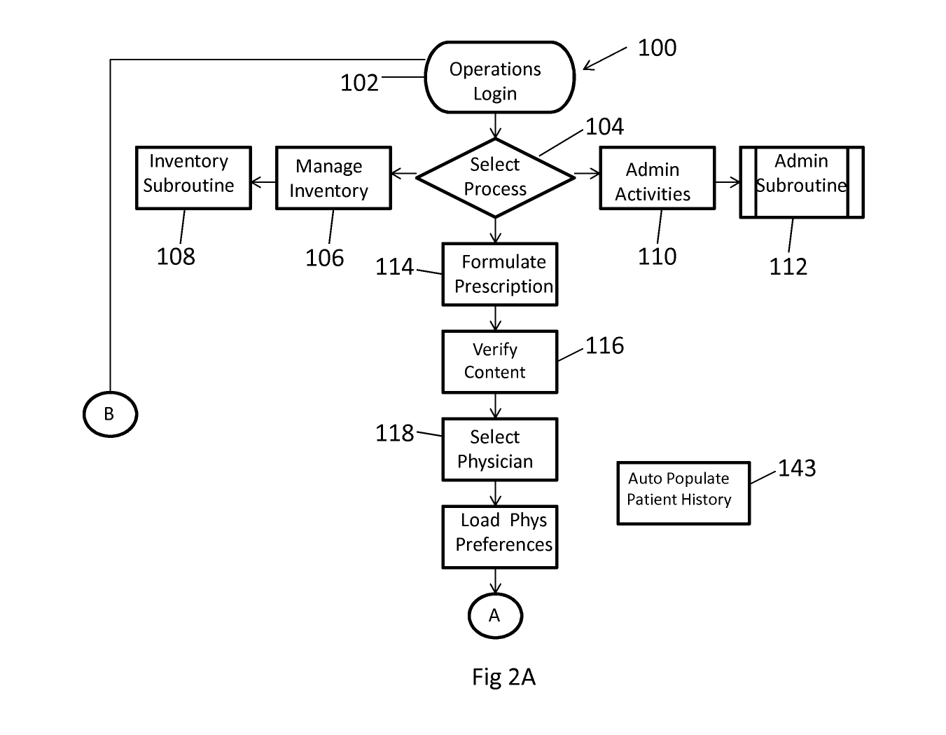

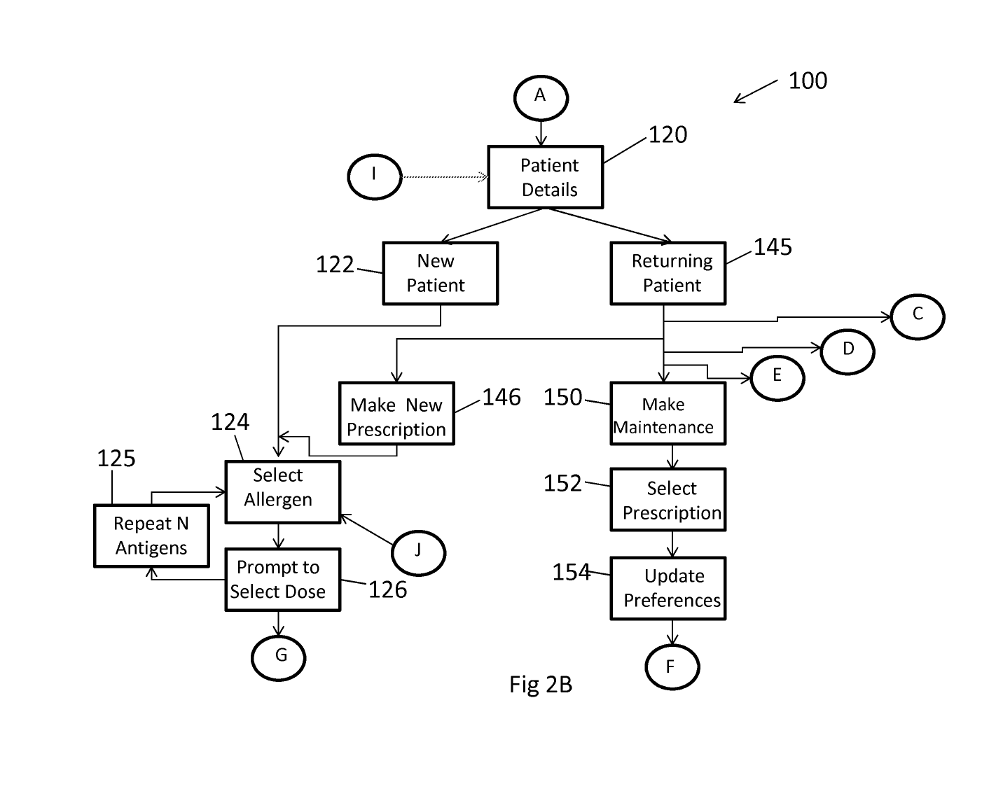

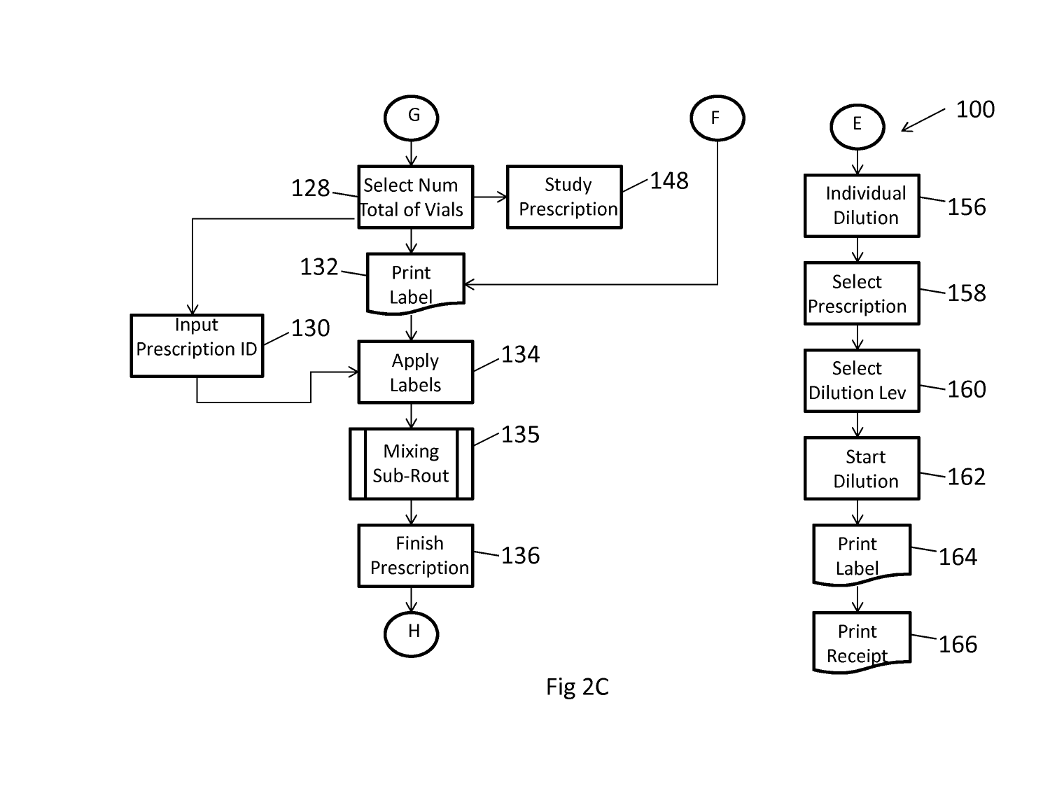

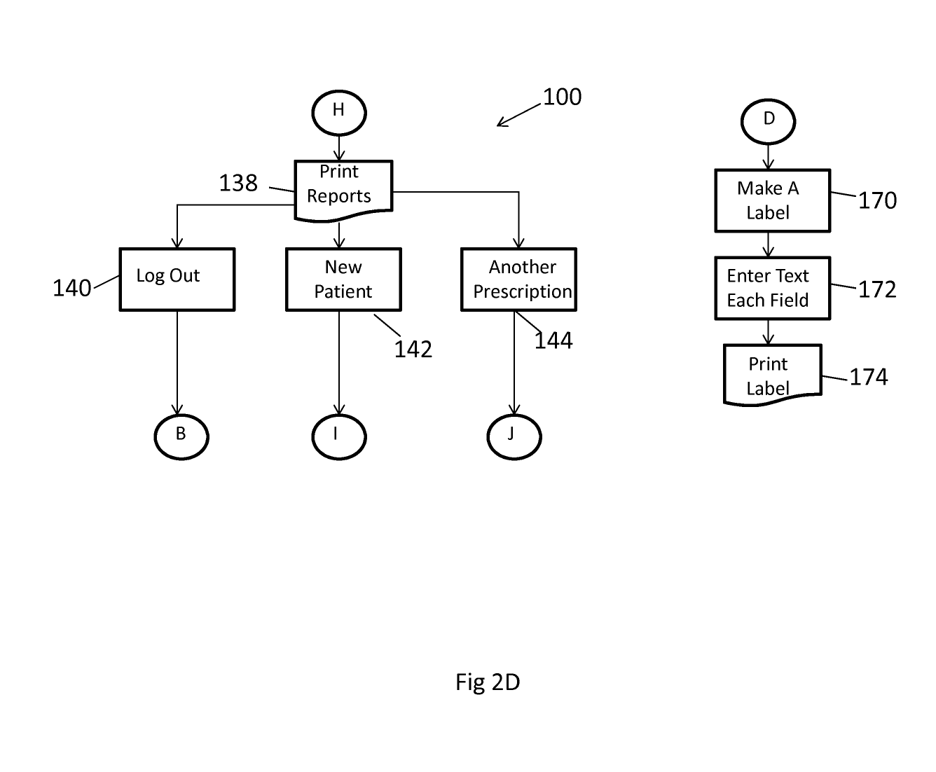

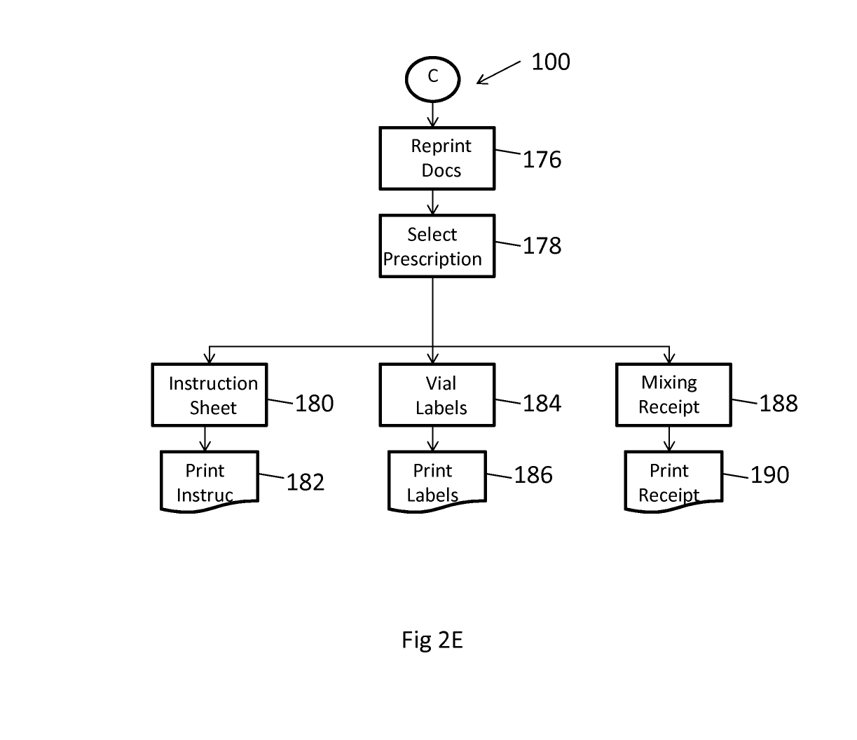

FIG. 2A-2E is a high level flow chart generally designated 100 illustrating integrating clinical documentation with the point of care treatment of a patient within a healthcare facility in connection with a patient care system for safe effective generation of immunotherapy patient treatment sets in accordance with one embodiment of the present invention.

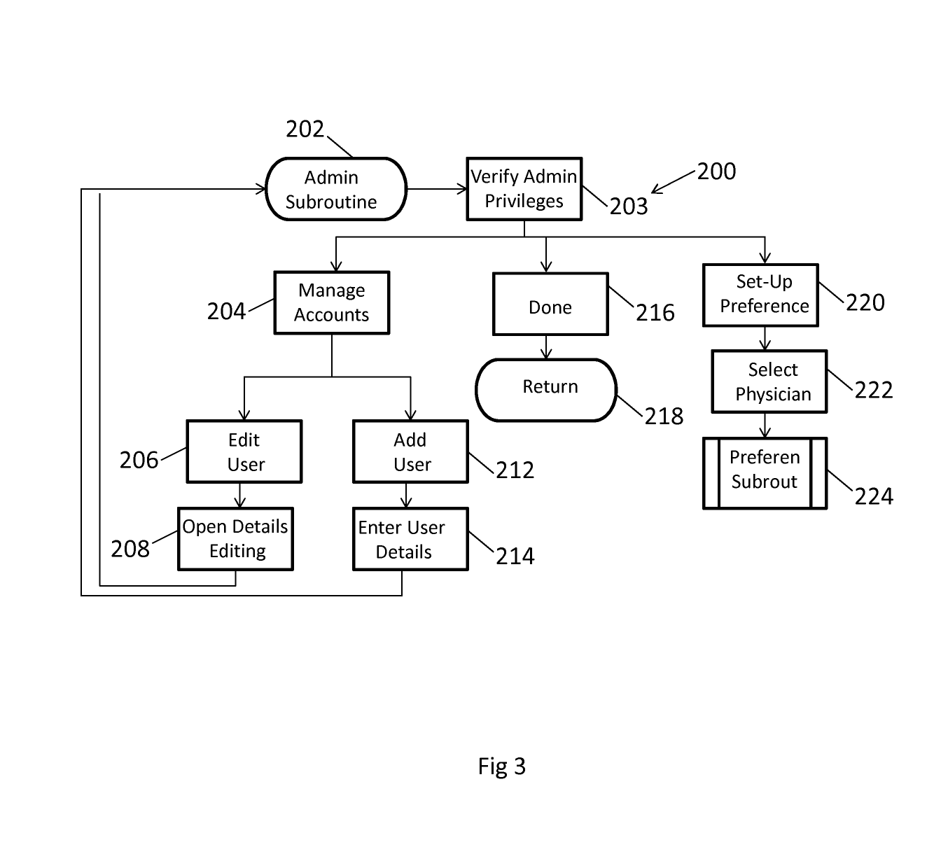

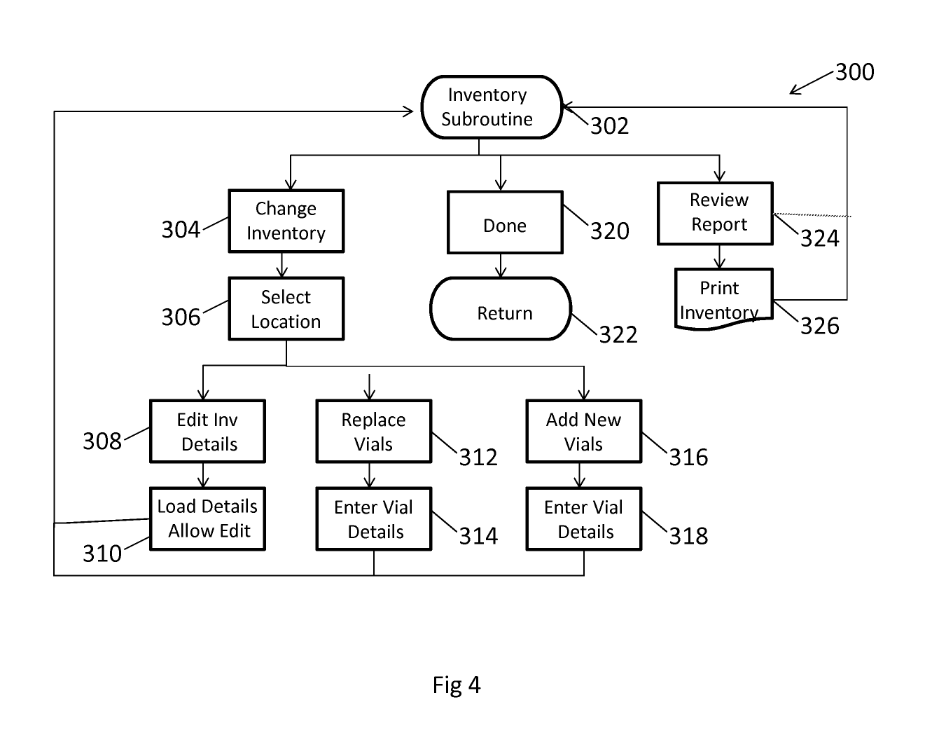

Integrating clinical documentation 100 includes Operator login, block 102; Select process, block 104; Manage inventory, block 106; and Inventory subroutine, block 108 (See FIG. 4). The integrating clinical documentation 100 includes Administrative activities, block 110; and Admin subroutine, block 112 (See FIG. 3) which includes managing user accounts, clinic preferences (Defaults), manage allergen abbreviations, manage dilution set colors (default red, yellow, blue, green, silver, violet), patient vial size (small vs. 10m1), and select reports to populate bottles.

Integrating clinical documentation 100 additionally includes Formulate a prescription, block 114; Verify the contents, block 116; Select physician, block 118 includes load prescription preferences, create prescription ID, prescription ID might need to be populated, Patient details, block 120; New patient, block 122; Select allergen, block 124; Prompt to select dose, block 126 a list should populate as the prescription is entered. Once entered the list should re-order to the order in which the antigens are loaded; and repeat for M (a predetermined number) antigens, 125; and select number total vials, block 128.

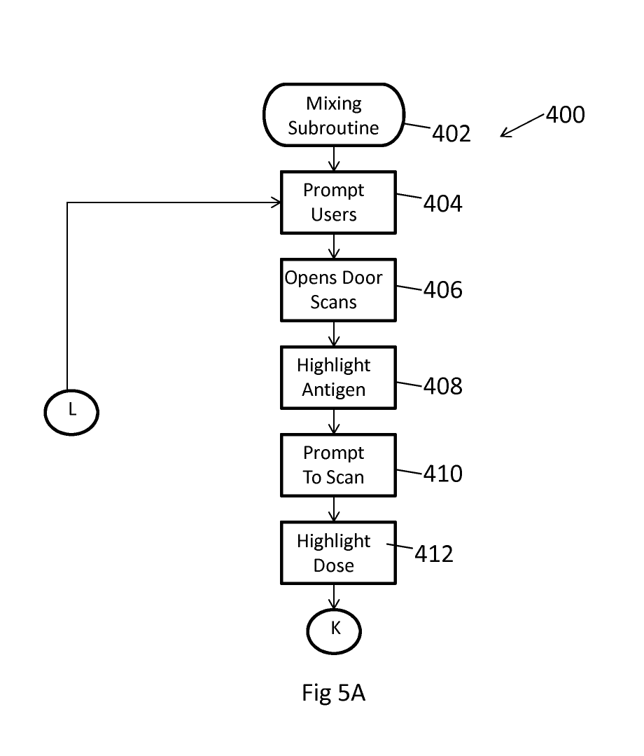

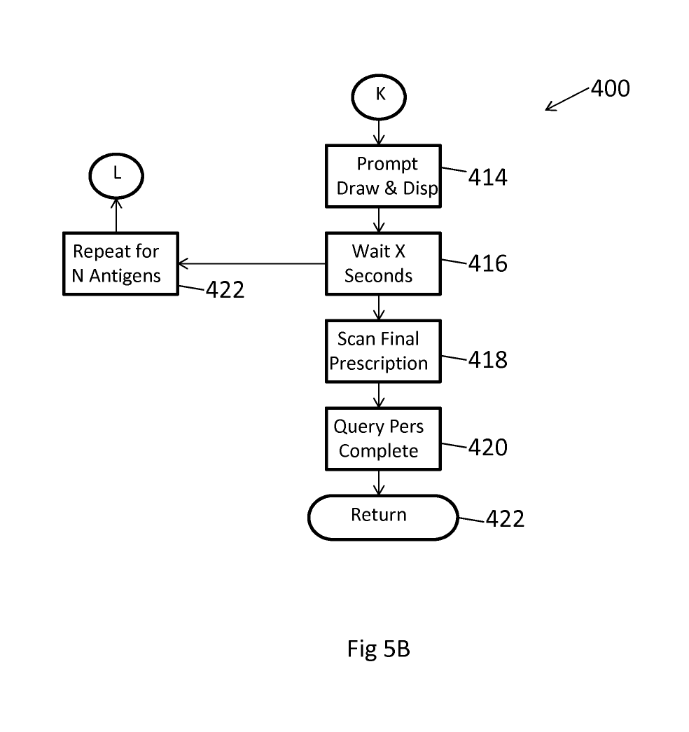

Integrating clinical documentation 100 further includes Input prescription ID, block 130; Print labels, block 132; Apply labels, block 134; Mixing subroutine, block 135 (See FIG. 5A-5B); Finish prescription entry, block 136; Print reports, block 138; Log out, block 140; New patient, block 142; Another prescription for new patient, block 144.

Additionally, integrating clinical documentation 100 includes Auto population patients list, block 143; Returning patient, block 145; Make new prescription, block 146 and study prescription characteristics, block 148.

Integrating clinical documentation 100 includes maintenance, block 150; Select prescription from patient history, block 152; and allow user to update prescription, block 154.

It further includes individual dilution, block 156; Select prescription from patient history, block 158; Select dilution level to create, block 160; Selecting starting dilution, block 162; Print labels, block 164; and Print receipt, block 166.

The documentation 100 includes Make a label, block 170; Enter text for each field in a label, block 172; and Print label, block 174.

Additionally documentation 100 includes Reprint documentation, block 176; Select prescription from patient history, block 178; Instruction sheet, block 180; Print instructions, block 182; Vial labels, block 184; Print labels, block 186; Mixing receipt, block 188; and Print receipt, block 190.

FIG. 3 is a high level flow chart generally designated 200 illustrating administration management in accordance with one embodiment of the present invention. Administration management 200 includes Admin subroutine, block 202; Verify admin privileges, block 203; Manage user accounts, block 204; Edit user, block 206; Open user details for editing, block 208; Add user, block 212 and Enter user detail, block 214. The Administration management 200 further includes admin privileges 203 includes Done, block 216 and return, block 218. Additionally, the Administration management 200 further includes the Admin subroutine includes set-up physician preference, block 220; select physician, block 222; and preferences subroutine, block 224 (See FIG. 5A-5B).

FIG. 4 is a high level flow chart generally designated 300 illustrating inventory management in accordance with one embodiment of the present invention. Inventory management 300 includes an inventory subroutine, block 302; Change inventory, block 304; Select location, block 306; Edit inventory details, block 308; Load details and allow editing, block 310; Replace vials, block 312; Enter vial details, block 314; Add new vials, block 316 and Entire vial details, block 318. Inventor management 300 further includes done, block 320; return, block 322; review inventory report, block 324; and print inventory, block 326.

FIG. 5A-5B is a high level flow chart generally designated 400 illustrating mixing management in accordance with one embodiment of the present invention. Mixing management 400 includes mixing subroutine, block 402; prompt user to select allergen (N=(N−1)), block 404; user opens door and scans, block 406; highlight antigen in prescription, block 408; prompt to scan dose, block 410; highlight dose in prescription, block 412; prompt user to draw and dispense, block 414; wait X (a predetermined amount) seconds, block 416; and repeat for N antigens, 417. Mixing management 400 includes user scans final prescribed, block 418; query prescription complete, block 420; and return, block 422.

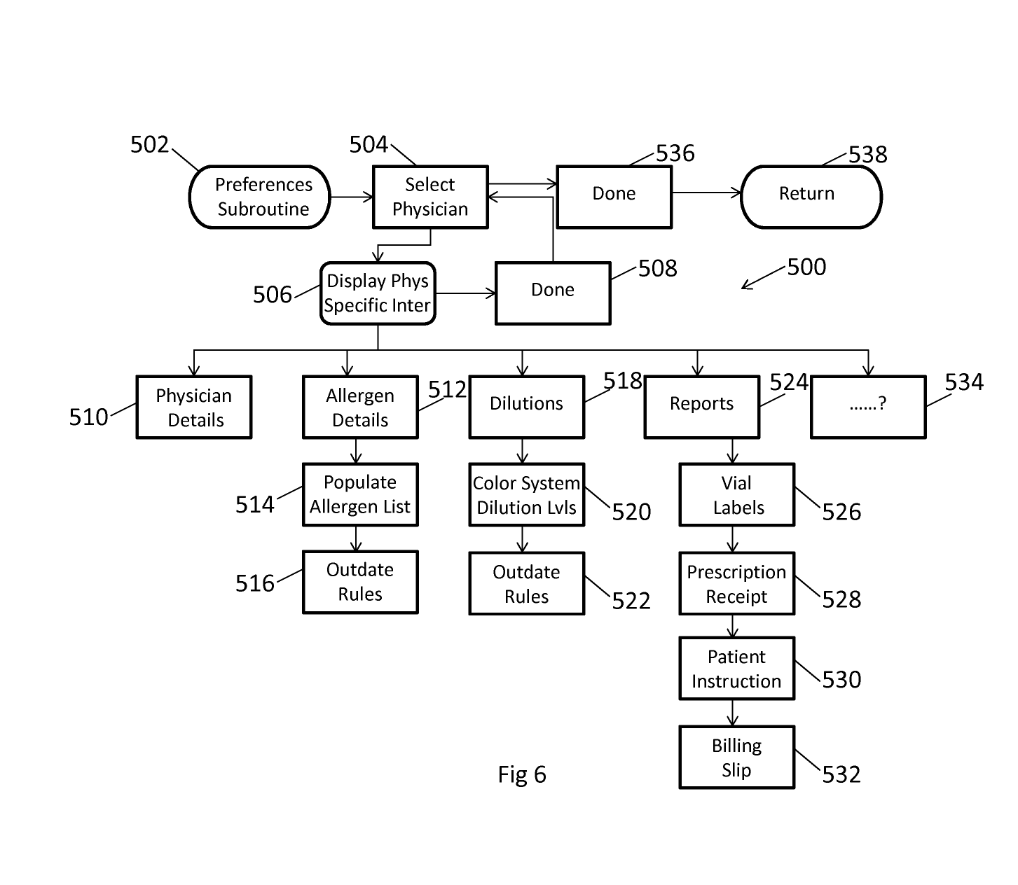

FIG. 6 is a high level flow chart generally designated 500 illustrating preferences management in accordance with one embodiment of the present invention. Preferences management 500 includes Preferences subroutine, block 502; Select physician (or add new), block 504; Display physician specific interface, block 506 and Done, block 508. Preferences management 500 further includes Physician Details, block 510; Allergen Details, block 512; Populate allergen list (ABV/Dilution), block 514; add Outdate rules, 516. Additionally preferences management 500 includes Dilutions, block 518; Color system and dilution levels, block 520; Outdate rules, block 522; reports, block 524; Vial labels, block 526; Prescription receipt, 528; Patient instructions, 530; Billing slip, block 532; Other routines, block 534; Done, block 536 and Return, block 538.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. One or more computer-readable media embodying computer-useable instructions for performing a method for point of care treatment of a patient for safe effective generation of immunotherapy patient treatment sets, the method comprising:
receiving a command to formulate a prescription;
loading contents of each door;
receiving a command to load physician preferences;
loading physician preferences;
receiving a command to load patient information; and
making prescription per patient information in accordance with physician preferences.

2. The computer-readable media of claim 1 further comprising instructions for printing and applying labels to prescription.

3. The computer-readable media of claim 1 further comprising instructions for documenting a plurality of clinical activities.

4. A non-transitory computer-readable medium containing program code for providing a point of care treatment of a patient for safe effective generation of immunotherapy patient treatment sets comprising:
program code for receiving a command to formulate a prescription;
program code for loading contents of each door;
program code for receiving a command to load physician preferences;
program code for loading physician preferences;
program code for receiving a command to load patient information; and
program code for making per patient information in accordance with physician preferences.

5. The non-transitory computer-readable medium of claim 4 further comprising program code for printing and applying labels to prescription.

6. The non-transitory computer-readable medium of claim 4 further comprising program code for documenting a plurality of clinical activities.

7. A system for providing a point of care treatment of a patient for safe effective generation of immunotherapy patient treatment sets comprising:
a server configured with a database, the database storing program code for establishing an auction house by enrolling at least one member:
program code for receiving a command to formulate a prescription;
program code for loading contents of each door;
program code for receiving a command to load physician preferences;
program code for loading physician preferences;
program code for receiving a command to load patient information; and
program code for making per patient information in accordance with physician preferences.

8. The system of claim 7 further comprising a printer for printing and applying labels to prescriptions using program code for printing and applying labels to prescription.

9. The system of claim 7 further comprising program code for documenting a plurality of clinical activities.

10. The system of claim 7 further comprising at least one medical grade touch panel computer.

11. The system of claim 7 including at least one keyboard and monitor.

12. The system of claim 7 further comprising a barcode reader or scanner to read vial identifiers and dosing keys.

13. The system of claim 7 further comprising a paper printer.

14. The system of claim 7 further comprising a barcode scanner.
